(19) United States
(12) Patent Application Publication
(10) Pub. No.: US 2026/0243181 A1
(43) Pub. Date: Aug. 20, 2026

(54) METHOD FOR PROCESSING AN ELECTRICAL SIGNAL, AND CONTROL DEVICE FOR A CAMSHAFT ADJUSTER OR INTERNAL COMBUSTION ENGINE FOR CARRYING OUT THE METHOD

(71) Applicant: Schaeffler Technologies AG & Co. KG, Herzogenaurach (DE)

(72) Inventor: Christian KARBACHER, Herzogenaurach (DE)

(73) Assignee: Schaeffler Technologies AG & Co. KG, Herzogenaurach (DE)

(21) Appl. No.: 19/471,427

(22) PCT Filed: Feb. 28, 2024
(86) PCT No.: PCT/DE2024/100159

§ 371 Date: Oct. 1, 2025

(30) Foreign Application Priority Data
Apr. 3, 2023 (DE) 102023108400.3

(51) Int. Cl. F01L 13/00

(52) U.S. Cl. CPC F01L 13/00; F01L 2013/111; F01L 2013/113

(57) ABSTRACT

A method for processing an electrical signal that is generated continuously over time and based on measurement values from a sensor and is transmitted via a line that is subject to disturbance variables, having the following features: establishing a scanning rate interval, establishing quantization levels, assigning the electrical signal to a quantization level, determining the number of changes in the quantization level in the scanning rate interval, rejecting all even-numbered changes in the quantization level within the scanning rate interval. A control device for a camshaft adjuster or for an internal combustion engine, which carries out a method of this kind.

### CROSS-REFERENCE TO RELATED APPLICATIONS

This application is the U.S. National Phase of PCT Appln. No. PCT/DE2024/100159, filed Feb. 28, 2024, which claims the benefit of German Patent Appln. No. 102023108400.3, filed Apr. 3, 2023, the entire disclosures of which are incorporated by reference herein.

### TECHNICAL FIELD

The disclosure relates to a method and control device for processing an electrical signal that is generated continuously over time and based on measurement values from a sensor and is transmitted via a line that is subject to disturbance variables.

### DISCLOSURE

### Background

Various operating methods for camshaft adjusters are described in DE 102 59 133 A1 and DE 102 42 659 A1. In particular, these publications deal with the interaction of an engine control unit with the camshaft adjuster. Wobble plate gears, which function as three-shaft gears, are used as actuating gears for the camshaft adjusters.

DE 10 2012 219 297 A1 describes a method for operating a motor vehicle which comprises an engine control device and additionally a camshaft adjuster control device. A CAN bus is provided for data transmission. The camshaft adjuster control device can be started before the engine control device start-up is completed.

WO 2006/122 665 A1 describes a topology for generating an actuating signal for an electrically actuated camshaft adjuster. A control device is integrated into a regulation unit in said document. Hall sensors are provided to detect states of the camshaft adjuster.

DE 10 2004 041 232 B4 describes a method for operating a camshaft adjuster which may comprise an electric or a hydraulic actuating device. In either case, reference and/or base values relating to the state of the camshaft adjuster are obtained by averaging values from different points in time in the course of the operating method.

In electric camshaft adjusters, as in engine control devices, the electrical signals from sensors on trigger wheels of crankshafts and camshafts are evaluated. Unlike in engine control devices, the lines between the control devices and the sensors are comparatively long. The lines in the engine compartment are exposed to a variety of disturbances.

Mass shifts due to high current loads and incident electromagnetic radiation give rise to voltage peaks and signal noise in the useful signal. Due to the increasing electrification of vehicles, the number of disturbance influences is also increasing, such that reliable signal transmission over long lines can no longer be guaranteed.

Signal evaluation is therefore generally difficult and more complex than in engine control devices.

### SUMMARY

The object of the disclosure is to avoid the disadvantages of the prior art and in particular to process an electrical signal that has been exposed to electrical disturbance.

This object is achieved according to the disclosure by a method for processing an electrical signal. The object is likewise achieved by a control device. The configurations and advantages of the disclosure explained below in connection with the control device also apply analogously to the method, and vice versa.

The method according to the disclosure is based on the finding that the voltage peaks and signal noise components radiated into many useful signals have a different temporal duration than their average change. If the temporal and/or magnitude change of the useful signal is approximately known in advance, the proposed method offers a simple way to eliminate disturbance influences without having to resort to a computationally intensive Fourier transform unit.

The method according to the disclosure is suitable, for example, for signals with continuously changing values. Continuous change should be understood in the mathematical sense that there are no abrupt changes in the signal. This applies, for example, to signals that are measurement values of continuously changing variables.

The method is also well suited to signals whose value changes abruptly if the time of the change is predictable within certain limits, especially if the changes occur periodically.

It is particularly suitable for digital signals or analog signals with pronounced edges. For example, a Hall sensor can detect the speed of rotation of a shaft using a trigger wheel. Trigger wheels have toothing that is easy to detect using magnetic sensing because an edge peak is generated due to the proportionality of the induced voltage to the first derivative of the field change. This does not need to be recorded in its absolute value, but can simply be registered as present/absent and therefore only needs to be counted.

A prerequisite for the method is that a suitable scanning rate interval can be selected. This requirement is easy to fulfill for many applications, since a measurement can be based on previously measured measurement values, for example, and many physical variables do not change suddenly. If there are no historical measurements that can be used meaningfully, assumptions can be checked for plausibility. For example, for a stationary motor, the speed of its motor shaft can be assumed to be zero.

The scanning rate interval can be set to a fixed value. For this purpose, it is, for example, hardware-coded or established once at the start of the method without any subsequently change. Alternatively, the scanning rate interval is established by open- or closed-loop control. The re-establishing can occur after each measurement or can be linked to predetermined time periods, measurement values and/or external conditions.

Quantization levels are also specified for the method. Their number and level depends on the application, for digital signals, two quantization levels are sufficient.

According to the method of the disclosure, the number of changes in the quantization level is determined. A change in the measurement value only occurs if a certain threshold is exceeded, such that the measurement value is assigned to a different quantization level. This reliably eliminates noise and random fluctuations.

In many applications, disturbance variables that affect the electrical signal are due to long cables. Disturbance variables are usually reflected in the signal curve through the first derivative of the disturbance, which is why voltage peaks occur. The disclosure takes advantage of the fact that these voltage peaks are comparatively short in duration and cause no change or a double change in the quantization interval. If the scanning rate interval is significantly larger, for example an order of magnitude larger, than the duration of the average voltage peaks caused by disturbance radiation, a double change in the quantization level can be safely attributed to disturbance influences. The method according to the disclosure therefore rejects all even-numbered changes in quantization level within the scanning interval.

In a further development, if there is an odd number of changes in the quantization level within a scanning rate interval, all changes in the quantization levels in the scanning rate interval following the first change are rejected. It is therefore only determined whether there is an odd or even change in the quantization levels within the scanning rate interval. As a result, it does not matter whether a voltage peak due to disturbance radiation occurs before or after the change in the useful signal.

The proposed method is particularly suitable for digital signals. However, it is also suitable for analog signals that are quantized into two or more quantization levels after transmission through the line.

Due to its high robustness, the method according to the disclosure enables the use of comparatively long lines without additional requirements being placed on their shielding. This also opens up possibilities for placing a control device that evaluates the signals further away, so permitting a more flexible installation location in an internal combustion engine, such that the control device is exposed to less heat or better packaging is enabled.

In addition to the voltage peaks caused by EMC radiation, noise also complicates the evaluation of edge peaks. The quality of the signal can be further improved by filtering it beforehand. For this purpose, for example, a low-pass filter is provided. Furthermore, hysteresis can be processed by a logic filter that evaluates the individual edge patterns.

In a further development, in the case that two scanning rate intervals with odd-numbered changes in the quantization level follow one another, the number of changes in the quantization level in the current and previous scanning rate interval is set to zero. This is based on the consideration that the measurement value either fluctuates around the threshold that separates the quantization levels or that the two edges of a disturbance viable are randomly distributed over two different scanning intervals.

The proposed method is particularly suitable for a control device of an electric or hydraulic camshaft adjuster of an internal combustion engine that carries out the method steps. The internal combustion engine is designed as a reciprocating piston engine and comprises a crankshaft and at least one camshaft in a basic structure known per se. An electromechanically adjustable actuating gear, which is for example a three-shaft gear, in particular a harmonic drive, is provided for adjusting the camshaft. The camshaft adjuster can be operated as follows:
the angular position of the crankshaft is continuously determined, wherein angular changes are incrementally detected starting from a detected angular reference position;
a reference position of the camshaft is detected, in particular with the aid of a trigger disk;
the current angular position of the camshaft and the crankshaft is calculated from the recorded angle changes of the rotor;
the difference between the two stated angular positions, i.e., the phase difference between the crankshaft and the camshaft, is calculated and used to control the electric motor driving the adjusting shaft.

The reference position of the camshaft is detected, wherein the corresponding signal is usually in any event made available to the engine control device of the internal combustion engine. The stated signal contains edge peaks that can be counted.

The angular changes of the crankshaft are detected with a finer resolution than the angular changes of the rotor of the electric motor, which is coupled for conjoint rotation to the adjusting shaft of the actuating gears. Due to the given positive or negative reduction ratio of the actuating gears, a very fine resolution of the angular position of the camshaft is possible.

In a preferred method, the angular positions of both the crankshaft and the rotor of the electric motor, which lie between two positions that can be discretely distinguished from one another with the aid of sensor signals, are determined approximately by calculation through temporal extrapolation. It is assumed that the shaft in question, i.e., the motor shaft of the electric motor or the crankshaft, is rotating at a virtually constant speed during the period to which the interpolation refers.

The internal combustion engine comprises a crankshaft, at least one camshaft that is adjustable electromechanically via an actuating gear, in particular a harmonic drive, an engine control device, and a camshaft control device that is provided for controlling an actuating motor, namely an electric motor, which operates the actuating gears, wherein the engine control device is linked to a device for detecting the angular position of the crankshaft, and the camshaft control device is linked to the engine control device, and wherein a device for detecting a reference position of the camshaft to be adjusted and a device for detecting the angular position of the shaft of the actuating motor are provided as sole means for detecting the angular position of the camshaft, and the camshaft control device is configured to determine the phase angle of the camshaft in relation to the crankshaft on the basis of the information provided by said devices in combination with the detected angular position of the crankshaft and the transmission ratio of the actuating gear.

The electric actuating motor of the camshaft adjuster is, for example, in the form of a permanent-magnet synchronous motor. The electric motor has, for example, four or six pairs of poles. Changes in the angular position of the rotor of the electric motor can be detected, for example, with the aid of Hall sensors.

According to one possible embodiment, the engine control device comprises a memory that stores the edges of a crankshaft trigger wheel detected during rotation of the crankshaft. By detecting rising edges as well as falling edges, not only can a higher resolution be achieved compared to detecting only edges of the same kind, but also a checking mechanism regarding the freedom of the recorded data from logical inconsistencies can be implemented. This type of signal processing can also be implemented in the camshaft control device. Similarly, the camshaft control device comprises a memory.

Within the scanning rate interval, a maximum of one pulse is counted, all the other pulses being rejected. The following applies: If an even number of pulses has occurred (e.g., rising-falling, falling-rising, falling-rising-falling-rising, etc.), then it is a disturbance and these pulses are completely ignored. If an odd number of pulses has occurred (e.g., rising, rising-falling-rising, rising-falling-rising-falling-rising, falling-rising-falling-rising-falling, etc.), then only the first edge in the respective occurring direction is evaluated, the later following edges being rejected.

The evaluation of the edge patterns from the useful signal and the suppression of edge peaks that are due to disturbance variables works particularly reliably if the scanning rate interval is not chosen to be constant, but is adjusted to the expected signal sequence. Therefore, a further development provides that the scanning rate interval depends on the speed of the shaft to be measured. The scanning rate interval must be selected such that it is smaller than the expected minimum duration between two useful pulses and larger than the typical duration of a disturbance.

Evaluation in the control device, which is carried out in this way by counting pulses, frees up computing capacity that can be used for other tasks. For example, a multiple edge angle calculation of the camshaft and crankshaft can be carried out in order to be able to perform a fallback calculation in the event of loss of the crankshaft sensor signal or one of the Hall signals.

For this purpose, a further development proposes to carry out a calculation for several cam edges (rising and falling) and/or a partial selection of the signals (e.g., using only every second or third value). For example, in the case of short bursts of interference, the chance of determining a plausible measurement value increases

### BRIEF DESCRIPTION OF THE DRAWINGS

The disclosure is explained in more detail below with reference to an exemplary embodiment. The exemplary embodiment relates to a control device for an electric camshaft adjuster and is illustrated schematically using figures. In the figures:

FIG. 1 shows an overview of the components of an internal combustion engine with an electromechanical camshaft adjuster,

FIG. 2 shows the interaction between an engine control device and a camshaft control device of the internal combustion engine,

FIG. 3 shows the relationship between measurements on the crankshaft and a camshaft of the internal combustion engine,

FIG. 4a shows a schematic, analog useful signal with disturbance signals,

FIG. 4b shows a schematic, digital useful signal with disturbance signals,

FIGS. 5a-h show various possible signal patterns that can occur within a scanning rate interval.

### DETAILED DESCRIPTION

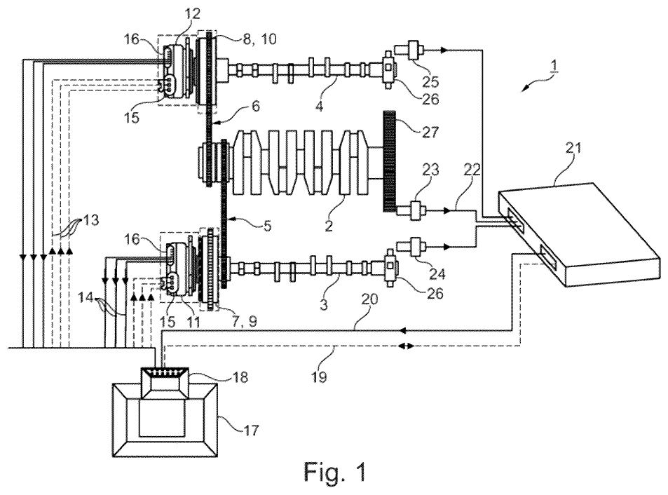

An internal combustion engine constructed as an in-line engine and identified overall in FIG. 1 with the reference sign 1 comprises a crankshaft 2 and two camshafts 3, 4, namely an intake camshaft 3 and an exhaust camshaft 4. Deviating from the exemplary embodiment shown, the internal combustion engine could also be a reciprocating piston engine of a different design, for example a V-engine, which has two intake and two exhaust camshafts.

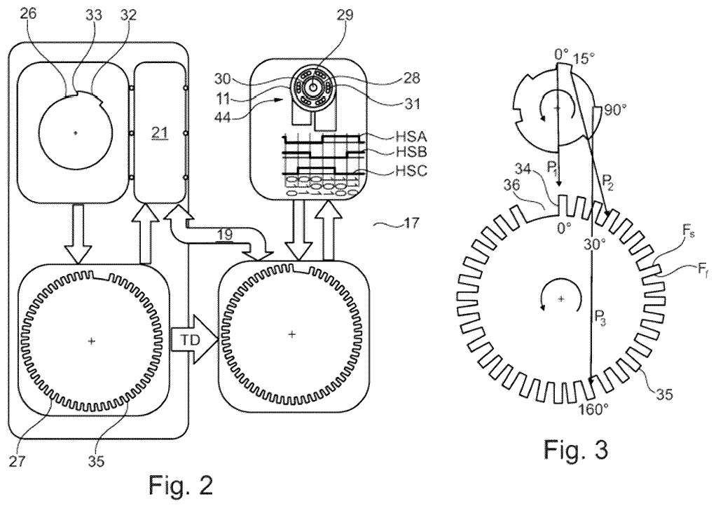

The camshafts 3, 4 are driven by the crankshaft 2 via chain gears 5, 6. Each camshaft 3, 4 is adjustable with the aid of an electromechanical camshaft adjuster 7, 8. The camshaft adjusters 7, 8 each have a three-shaft gear constructed as a harmonic drive as the actuating gears 9, 10. A shaft on the input side of the actuating gears 9, 10 is driven by the chain gears 5, 6. The shaft of the actuating gears 9, 10 on the output side is connected for conjoint rotation to the camshaft 3, 4 to be adjusted. A third shaft of each actuating gear 9, 10 can be driven by an electric motor 11, 12 associated with the respective camshaft adjuster 7, 8. Here, the motor shaft, denoted 29 (FIG. 2), of the electric motor 11, 12, on which a rotor 28 is mounted, is coupled for conjoint rotation to the third shaft of the actuating gears 9, 10, optionally via a compensating coupling. In the exemplary embodiment, the “third shaft” is an inner ring of a wave generator of the actuating gears 9, 10 in the form of a harmonic drive.

The electric motors 11, 12 are connected to a camshaft control device 17 via connecting lines 13 and signal lines 14. Plug-and-socket connections of the electric motor 11, 12 for the connecting lines 13 are denoted 15, and plug-and-socket connections for the signal lines 14 are denoted 16. The stated lines 13, 14 are connected to a plug-and-socket connection 18 of the camshaft control device 17. Hall signals, which are obtained with the aid of Hall sensors (not shown), are transmitted via the signal lines 14 and provide information about changes in the angular position of the rotor 28. The Hall sensors are attributable to a rotor position detection device denoted overall 44.

The camshaft control device 17 is connected to the engine control device, denoted 21, of the internal combustion engine 1 via a data bus 19, namely a CAN bus, and a signal line 20. A crankshaft sensor 23 is connected to the engine control device 21 via a crankshaft line 22. The crankshaft sensor 23 scans a crankshaft trigger wheel 27 which is fixed to the crankshaft 2. Sensors 24, 25 are furthermore connected to the engine control device 21, each of which interacts with a trigger disk 26 connected to a camshaft 3, 4.

FIG. 2 illustrates data processing operations in the engine control device 21 (left) and in the camshaft control device 17 (right). As can be seen from the illustration, the signal generated with the aid of the trigger disk 26 is processed within the engine control device 21. In the exemplary embodiment, the trigger disk 26 schematically has a single elevated portion 32. An edge of the elevated portion 32 is denoted 33. The edge 33 of the trigger disk 26 provides a camshaft trigger in per se known manner. A logical link is established between the camshaft trigger and the scanning of the crankshaft trigger wheel 27.

The crankshaft trigger wheel 27 has teeth 35 which, together with an adjacent gap located between two teeth 35, each cover an angle of 6°. A recess 36 is formed by omitting two teeth, wherein the first tooth 35 adjacent to the recess 36 is a reference mark 34. The signal detected with the aid of the reference mark 34 is also denoted the TD signal. A copy of this TD signal, to which a further mark can be added, is sent from the engine control device 21 to the camshaft control device 17 via the signal line 20. Within the camshaft control device 17, the TD signal indicating a reference angular position of the crankshaft is logically linked to features of the electric motor 11, 12.

FIG. 2 shows permanent magnets 30 and windings 31 of the electric motor 11, 12. A possible profile of Hall signals HSA, HSB, HSC, which provide information about changes in the angular position of the rotor 28, is shown schematically. Each combination of the Hall signals HSA, HSB, HSC corresponds to a bit pattern, in the exemplary embodiment the bit patterns 010, 011, 001, 101, 100 and 110.

As shown in FIG. 3, a rising edge Fs and a falling edge Ff are provided by each tooth 35. With a good approximation, it can be assumed that the crankshaft speed does not change during further rotation by one tooth 35. Thus, a time interval that indicates a partial period of time when the crankshaft 2 continues to rotate from one tooth 35 to the next tooth 35, can be used to calculate any angular position of the crankshaft 2 lying between two teeth 35. In this way, the camshaft reference position, i.e., the angular position of the camshaft 3, 4 at which the edge 33 is detected, can also be assigned to an exact angular position of the crankshaft 2.

In a comparable manner, the bit patterns generated during operation of the electric motor 11, 12 are used to extrapolate angular positions of the camshaft 3, 4. This calculation also assumes that the motor shaft 29 is rotating within the relevant angular range at an approximately constant angular velocity.

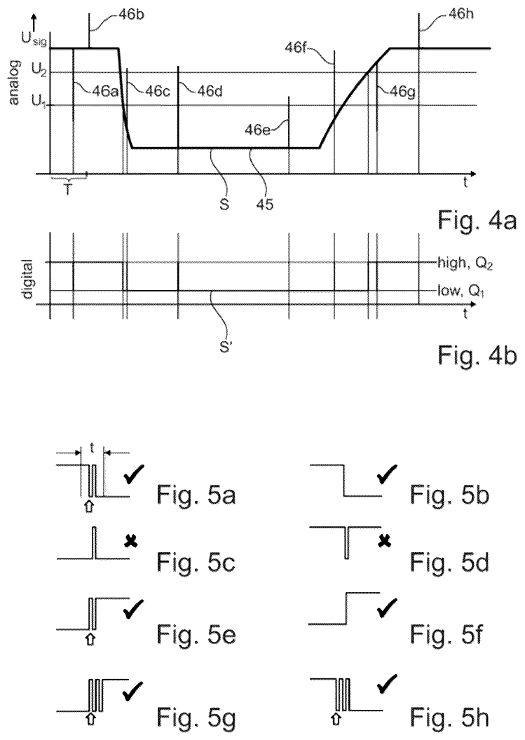

FIG. 4a shows a signal S which is received and processed by one of the control devices 17, 21. The applied voltage is plotted overtime. The signal S consists of a useful signal 45 with superimposed disturbance pulses 46a to 46h. Due to the short duration of the disturbance signals, they induce voltages which appear as peaks due to their short duration.

The electrical signal S is analog and is transformed into a digital signal S′ in a first step. Two quantization levels Q₁, Q₂, which are also denoted low and high, are provided for the digital signal. Assignment to one of the quantization levels is performed as follows:

If the signal voltage is above an upper threshold U2, the assignment is to quantization level Q2 regardless of the actual level. Similarly, if the signal voltage is below a lower threshold value U1, it is assigned to quantization level Q1. This means that, for example, the disturbing pulses 46b and 46h have no influence on the assignment to quantization level Q1.

The range between the thresholds U1 and U2 defines a transition range. If the voltage exceeds or falls below one of the thresholds overtime and thus reaches the transition range, but without exceeding or falling below the other threshold, the quantization level Q₁, Q₂ is not reassigned. The disturbance pulse 46e therefore does not cause a reassignment because, although the voltage exceeds the lower threshold U1, it then falls below it again without having previously reached the level of the upper threshold U2. All the other disturbance pulses 46a, 46c, 46d, 46f and 46g are included in the digital signal S′.

In a next step, the number of changes in quantization level Q₁, Q₂ in the respective scanning rate interval T is established. All even-numbered changes in quantization level Q₁, Q₂ in the scanning rate interval T are rejected, such that only the first change is taken into account. As described below, this eliminates the disturbance pulses.

The disturbance pulse 46a that occurs in the first scanning rate interval T is shown in more detail in FIG. 5d. It forms a double edge and thus a double change in the quantization level Q₁, Q₂ and is therefore not counted. The same applies to the disturbance pulses 46d and 46f, which are shown enlarged in FIG. 5c. They also form a double edge and are therefore not counted.

The disturbance pulse 46c is located in the range in which the useful signal 45 is changes from quantization level Q₂ to the quantization level Q₁. The relevant scanning rate interval T is shown in FIG. 5a. There is an odd number of edges, so the first edge is considered as a change in the quantization level from Q₂ to Q₁. The same applies to the reverse transition, which in FIG. 4a is provided with a flatter signal rise and the two disturbance pulses 46f, 46g. The corresponding scanning rate interval is shown in FIG. 5g. The five edges again form an odd number, such that they count as a change in the quantization level Q₁, Q₂.

The resultant reduction in disturbance pulses 46a to 46h frees up computing power in the control device 17, 21, which is available for other calculations. FIG. 3 shows a trigger disk 26 which differs from that in FIG. 2 in that calculations are carried out on three edges. Using the values shown there, the phase angle is calculated in the case of

Arrow 1 to 2 × 0° − 0° = 0°,
Arrow 2 to 2 × 15° − 30° = 0°,
Arrow 3 to 2 × 90° − 160° = −20°

This allows redundancy to be achieved and also makes a control loop more stable.

### LIST OF REFERENCE SIGNS

1 Internal combustion engine
2 Crankshaft
3 Camshaft
4 Camshaft
5 Chain gears
6 Chain gears
7 Camshaft adjuster
8 Camshaft adjuster
9 Actuating gear
10 Actuating gear
11 Electric motor
12 Electric motor
13 Connecting line
14 Signal line
15 Plug-and-socket connection for connecting lines
16 Plug-and-socket connection for signal lines
17 Camshaft control device
18 Plug-and-socket connection of the camshaft control device
19 Data bus
20 Signal line
21 Engine control device
22 Crankshaft line
23 Crankshaft sensor
24 Sensor
25 Sensor
26 Trigger disk
27 Crankshaft trigger wheel
28 Rotor
29 Motor shaft
30 Permanent magnet
31 Winding
32 Elevated portion
33 Edge
34 Reference mark
35 Tooth
36 Recess
37 Evaluation unit
38 Ring buffer of the camshaft control device
39 Memory area
40 Memory area
41 Ring buffer of the engine control device
42 Memory area
43 Memory area
44 Rotor position detection device
45 Useful signal
46a-46h Disturbance pulses
Ff Falling edge
Fs Rising edge
HSA Hall signal
HSB Hall signal
HSC Hall signal
S Signal
S′ Digital signal
T Scanning rate interval
TD TD signal
P1 Arrow 1
P2 Arrow 2
P3 Arrow 3

1. A method for processing an electrical signal (S) that is generated continuously over time and based on measurement values from a sensor and is transmitted via a line that is subject to disturbance variables, the method comprising:
a) establishing a scanning rate interval (T),
b) establishing quantization levels (Q₁, Q₂),
c) assigning the electrical signal to a quantization level (Q₁, Q₂),
d) determining a number of changes in the quantization level (Q₁, Q₂) in the scanning rate interval (T),
e) rejecting all even-numbered changes in the quantization level (Q₁, Q₂) within the scanning rate interval (T).

2. The method according to claim 1, wherein, in the case of an odd number of changes in the quantization level (Q₁, Q₂) within a scanning rate interval (T), all changes in the quantization level (Q₁, Q 2) in the scanning rate interval (T) following a first change are rejected.

3. The method according to claim 1, wherein the electrical signal (S) is a digital signal or an analog signal which, after transmission through the line, is quantized into exactly two quantization levels (Q₁, Q₂).

4. The method according to claim 1, wherein the electrical signal (S) is filtered.

5. The method according to claim 1, wherein, in the case of two successive scanning rate intervals (T) with odd-numbered changes in the quantization level (Q₁, Q₂), the number of changes in the quantization level (Q₁, Q₂) in the current and previous scanning rate interval (T) is set to zero.

6. The method according to claim 1, wherein the sensor measures a continuously changing variable.

7. The method according to claim 6, wherein the sensor scans a trigger wheel of a camshaft or a crankshaft.

8. The method according to claim 1, wherein the scanning rate interval (T) is open- or closed-loop controlled by the measurement values.

9. The method according to claim 1, wherein the scanning rate interval (T) is shorter than 50 μs.

10. A control device, for a camshaft adjuster or for an internal combustion engine, for processing an electrical signal (S) that is generated continuously over time and based on measurement values from a sensor and is transmitted via a line that is subject to disturbance variables, the control device configured to:
a) establish a scanning rate interval (T),
b) establish quantization levels (Q₁, Q₂),
c) assign the electrical signal to a quantization level (Q₁, Q₂),
d) determine a number of changes in the quantization level (Q₁, Q₂) in the scanning rate interval (T),
e) reject all even-numbered changes in the quantization level (Q₁, Q₂) within the scanning rate interval (T).

11. The control device according to claim 10, wherein, in the case of an odd number of changes in the quantization level (Q₁, Q₂) within a scanning rate interval (T), all changes in the quantization level (Q₁, Q₂) in the scanning rate interval (T) following a first change are rejected.

12. The control device according to claim 10, wherein the electrical signal (S) is a digital signal or an analog signal which, after transmission through the line, is quantized into exactly two quantization levels (Q₁, Q₂).

13. The control device according to claim 10, wherein the electrical signal (S) is filtered.

14. The control device according to claim 10, wherein, in the case of two successive scanning rate intervals (T) with odd-numbered changes in the quantization level (Q₁, Q₂), the number of changes in the quantization level (Q₁, Q₂) in the current and previous scanning rate interval (T) is set to zero.

15. The control device according to claim 10, wherein the sensor measures a continuously changing variable.

16. The control device according to claim 15, wherein the sensor scans a trigger wheel of a camshaft or a crankshaft.

17. The control device according to claim 10, wherein the scanning rate interval (T) is open- or closed-loop controlled by the measurement values.

18. The control device according to claim 10, wherein the scanning rate interval (T) is shorter than 50 μs.
